(19) United States
(12) Patent Application Publication
(10) Pub. No.: US 2025/0075756 A1
(43) Pub. Date: Mar. 6, 2025

(54) SINGLE PISTON BRAKE CALIPER HOUSING AND A METHOD OF MANUFACTURING A SINGLE PISTON BRAKE CALIPER HOUSING

(71) Applicant: ArvinMeritor Technology, LLC, Troy, MI (US)

(72) Inventors: Daniel Philpott, Troy, MI (US); Jason A. Eaton, Troy, MI (US); Sukrut S. Sakhare, Troy, MI (US)

(73) Assignee: ArvinMeritor Technology, LLC, Troy, MI (US)

(21) Appl. No.: 18/460,050

(22) Filed: Sep. 1, 2023

(51) Int. Cl. F16D 65/00

(52) U.S. Cl. CPC F16D 65/0068; F16D 2055/0016; F16D 2250/003; F16D 2250/0084

(57) ABSTRACT

A brake caliper housing includes a first end wall; a second end wall disposed opposite the first; a transverse wall that extends from the first end wall to the second; and an interface wall that extends from the first end wall to the second and cooperates with the first and second end walls and the transverse wall to at least partially define a cavity and define a hole sized to receive a cutting tool adapted to machine a surface. A roller seat is defined in the transverse wall and supports a roller having a body with an end having a polygonal cross-section or an enlarged cross-section relative to a diameter of the body. The roller seat has flat abutment surfaces for accommodating the end of the roller.

### TECHNICAL FIELD

This disclosure relates to a brake caliper housing and a method of manufacturing a brake caliper housing.

### BACKGROUND

A brake caliper housing is disclosed in U.S. Patent Publication No. 2022/0090643.

### SUMMARY

According to at least one embodiment, a brake caliper housing includes a first end wall; a second end wall disposed opposite the first end wall; a transverse wall that extends from the first end wall to the second end wall; and an interface wall that extends from the first end wall, to the second end wall, opposite to the transverse wall. The interface wall cooperates with the first end wall, the second end wall, and the transverse wall to at least partially define a cavity. A roller seat is defined in the transverse wall adapted to support a roller having a body with an end having a polygonal cross-section or an enlarged cross-section when compared to a diameter of the body, the roller seat having flat abutment surfaces for accommodating the end of the roller.

### BRIEF DESCRIPTION OF THE DRAWINGS

FIG. 1 is a perspective view of an example of a brake assembly.

FIG. 2 is a perspective view of a portion of the brake assembly including an example of a brake caliper.

FIG. 3 is a rear side view of the portion of the brake assembly shown in FIG. 2.

FIG. 4 is a section view of the brake assembly along section line 4-4.

FIGS. 5 and 6 are exploded views of a portion of the brake assembly.

FIG. 7 is a partial rear perspective view of brake caliper housing according to an embodiment.

FIG. 8 is another partial rear perspective view of a brake caliper housing, enlarging the portion shown in FIG. 7.

FIG. 9A is a conventional partial roller seat cross-section of a brake caliper housing.

FIG. 9B is a partial roller seat cross-section of a brake caliper housing, according to an embodiment.

FIG. 10 is a partial rear view of the brake caliper housing with a cutting tool, according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It will also be understood that, although the terms first, second, etc. are, in some instances, used herein to describe various elements, these elements should not be limited by these terms. These terms are only used to distinguish one element from another. For example, a first element could be termed a second element, and similarly a second element could be termed a first element without departing from the scope of the various described embodiments. The first element and the second element are both elements, but they are not the same element.

The terminology used in the description of the various described embodiments is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

According to one or more embodiments, a brake caliper housing for a single piston brake assembly is provided. The brake caliper housing is provided with surfaces which supports rollers thereon. The rollers, according to one or more embodiments, have a body terminating in an end, with the end having a square cross-section. Thus, the roller has a tip that is square in nature with a flat end, as opposed to conventional spherical tip rollers. Additionally, the caliper housing surfaces, including surfaces of the operating shaft, are machined by a tool such that the surface geometry of the caliper housing which supports and abuts the rollers is optimized with abutment surfaces for receiving the square end rollers supported thereon. As such, the length of the roller seat in the caliper housing can be reduced and roller usage can be standardized across other brake assemblies which use square end rollers.

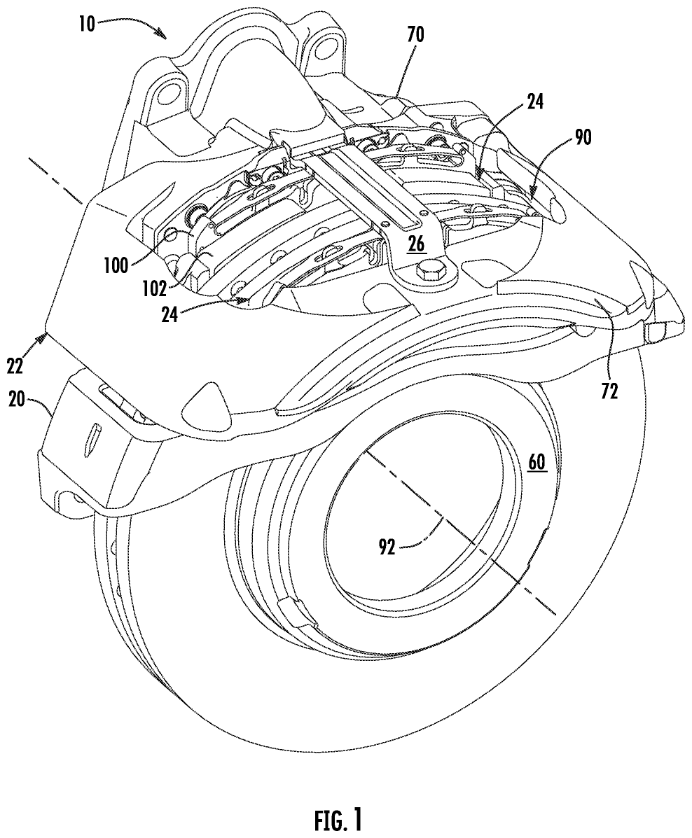

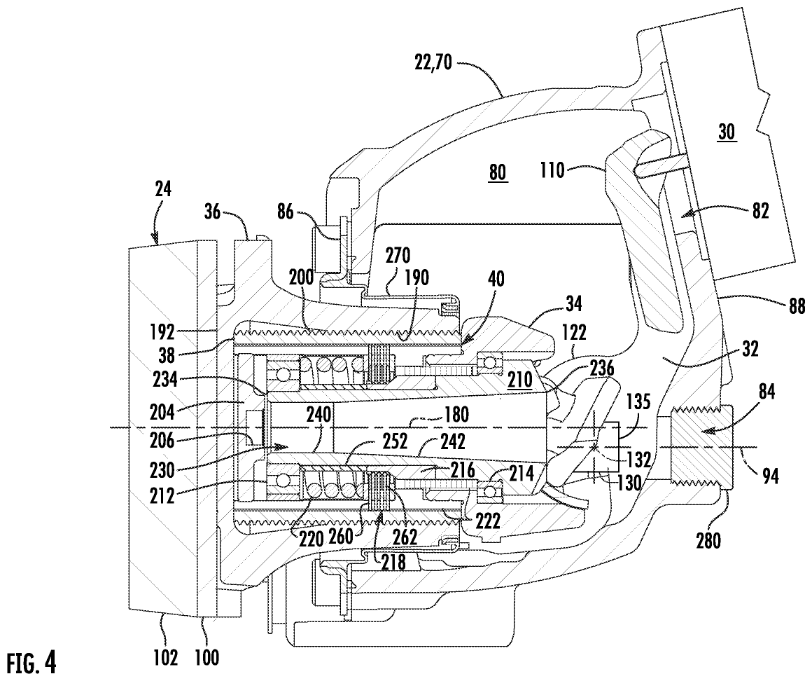

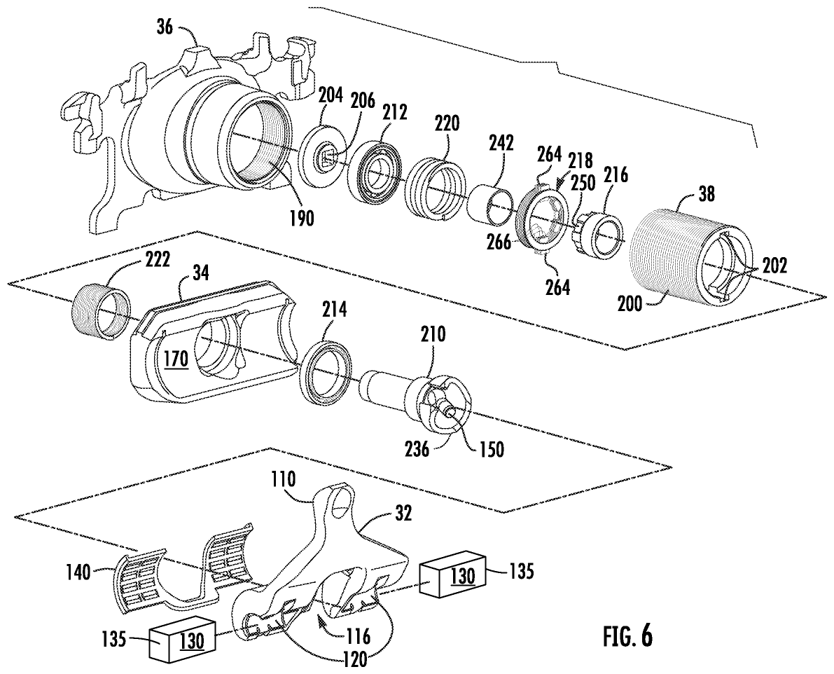

Referring to FIG. 1, an example of a brake assembly 10 is shown. The brake assembly 10 may be provided as part of a vehicle, such as a motor vehicle like a truck, bus, farm equipment, military transport or weaponry vehicle, or cargo loading equipment for land, air, or marine vessels. The brake assembly 10 may be configured as a disc brake. In at least one configuration, the brake assembly 10 may include a brake carrier 20, a brake caliper 22, a pair of brake pad assemblies 24, and optionally a retainer bracket 26. Referring primarily to FIGS. 4 and 6, the brake assembly 10 may include components that may facilitate movement of the brake pad assemblies 24, such as a brake actuator 30, an operating shaft 32, a yoke 34, a tappet 36, a piston 38, and a wear adjuster mechanism 40.

Referring to FIG. 1, the brake carrier 20 may be fixedly mounted to the vehicle. For example, the brake carrier 20 may be directly or indirectly mounted to an axle assembly or a steering knuckle. The brake carrier 20 may receive and support the brake pad assemblies 24 in a manner that permits the brake pad assemblies 24 to move along an axis toward and away from the brake rotor 60 while inhibiting rotation of the brake pad assemblies 24 about the axis. The brake carrier 20 may include a rotor opening that may receive a brake rotor 60. As such, the brake carrier 20 may straddle the brake rotor 60 and help position the brake pad assemblies 24 on opposite sides of the brake rotor 60.

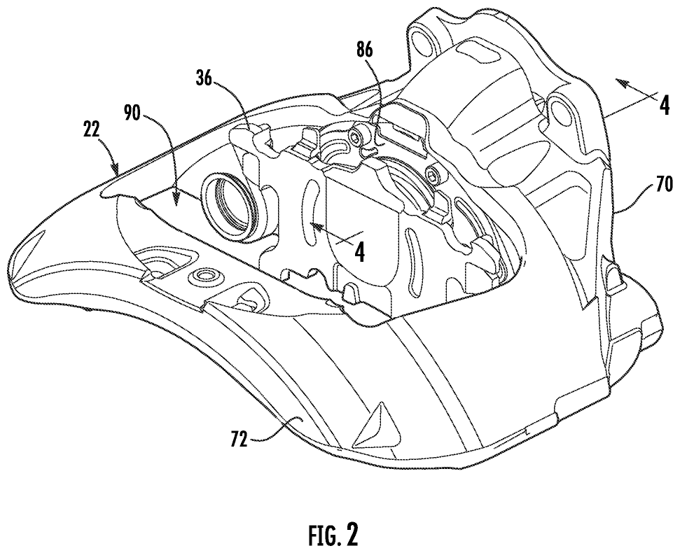

Referring to FIGS. 1 and 2, the brake caliper 22 may receive various components of the brake assembly 10. In addition, the brake caliper 22 may facilitate positioning of the brake pad assemblies 24 with respect to the brake rotor 60 to facilitate braking of the vehicle. In at least one configuration, the brake caliper 22 may be mounted to the brake carrier 20 and may include a caliper housing 70 and a caliper bridge 72.

The caliper housing 70 may be moveably disposed on the brake carrier 20. For example, the caliper housing 70 may be slidably disposed on a pair of guide pins that may be fixedly disposed on the brake carrier 20. As is best shown in FIG. 4, the caliper housing 70 may facilitate mounting of the brake actuator 30 and may define a cavity 80, an opening 82, and a hole 84.

The cavity 80 may receive or partially receive various components that facilitate movement of the brake pad assemblies 24, such as the operating shaft 32, yoke 34, tappet 36, piston 38, and the wear adjuster mechanism 40. The cavity 80 may have an aperture that may face toward the brake rotor 60 and that may be at least partially enclosed by a cover plate 86 that may be fixedly mounted to the caliper housing 70, such as with fasteners like bolts.

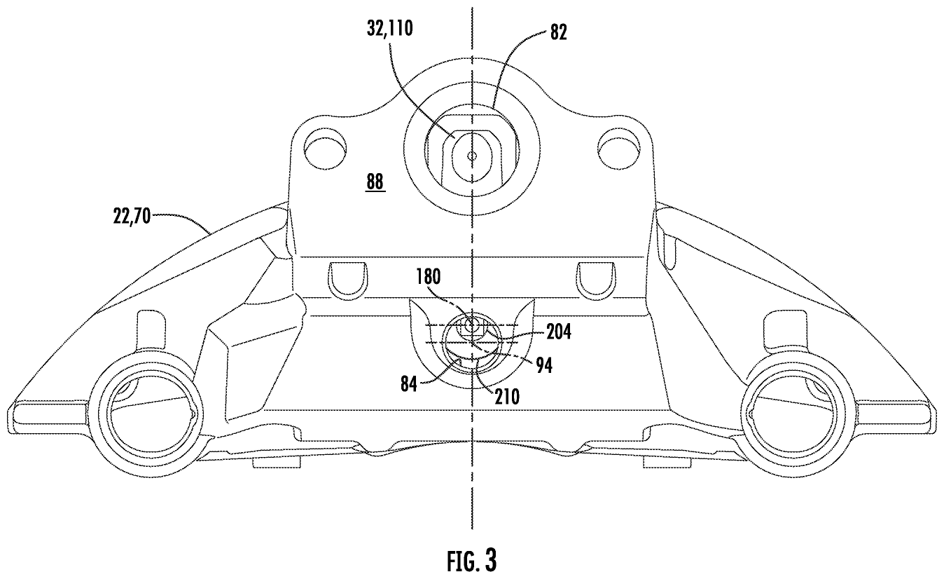

Referring to FIGS. 3 and 4, the opening 82 may extend from the cavity 80 through a back wall 88 of the caliper housing 70 that may face away from the brake carrier 20 and the brake rotor 60. In at least one configuration, a shaft of the brake actuator 30 may extend through the opening 82 to facilitate actuation of the operating shaft 32. The opening 82 may be disposed above an axis 180.

The hole 84 may be a through hole that may extend from the cavity 80 through the back wall, or interface wall, 88 of the caliper housing 70. The hole 84 may be spaced apart from the opening 82. The hole 84 may be sized such that a tool (e.g., a cutting tool or an adjusting tool) may be insertable and removeable through the hole 84 without disassembly of various components of the brake assembly 10 that facilitate movement of the brake pad assemblies 24, such as the wear adjuster mechanism 40. The hole 84 may be disposed above a brake rotor axis of rotation 92 and below the axis 180. For example, the hole 84 may be centered about a hole axis 94 that may be disposed above the brake rotor axis of rotation 92 and may be disposed below or may be otherwise offset from the axis 180. The hole 84 may receive a plug as will be discussed in more detail below.

Referring to FIGS. 1 and 2, the caliper bridge 72 may be integrally formed with or may be fixedly disposed on the caliper housing 70. For example, the caliper bridge 72 may be coupled to the caliper housing 70 with one or more fasteners, such as bolts. In at least one configuration, the caliper bridge 72 may cooperate with the caliper housing 70 to at least partially define an opening 90 that may facilitate insertion and removal of the brake pad assemblies 24.

Referring to FIG. 1, a pair of brake pad assemblies 24 may be received in and may be supported by the brake carrier 20. The brake pad assemblies 24 may be disposed on opposite sides of the brake rotor 60 and may be engageable with the brake rotor 60 to slow rotation of the brake rotor 60 and an associated wheel about a brake rotor axis of rotation 92. One brake pad assembly 24 may be positioned between the caliper housing 70 and the brake rotor 60 and may be referred to as an inboard brake pad assembly 24. The brake pad assembly 24 located on the opposite side of the brake rotor 60 may be positioned between the caliper bridge 72 and the brake rotor 60 and may be referred to as an outboard brake pad assembly 24. The brake pad assemblies 24 may include a backplate 100 and friction material 102.

The backplate 100 may be a structural member of a brake pad assembly 24. The backplate 100 may be configured as a generally flat plate and may be made of any suitable material, such as metal or a metal alloy. As is best shown in FIG. 4, a side of the backplate 100 that faces away from the friction material 102 may engage or contact the tappet 36.

The friction material 102 may be disposed on a side of the backplate 100 that may face toward the brake rotor 60. The friction material 102 may contact the brake rotor 60 during vehicle braking.

Referring to FIG. 1, the retainer bracket 26 may be removably mounted to the brake caliper 22. For example, the retainer bracket 26 may extend across the brake pad assemblies 24 and the opening 90 in the brake caliper 22 to help retain the brake pad assemblies 24 in the brake carrier 20 when the retainer bracket 26 is secured to the brake caliper 22. Conversely, the retainer bracket 26 may be detached from or removed from the brake caliper 22 to permit removal of the brake pad assemblies 24 or installation of the brake pad assemblies 24 via the opening 90.

Referring to FIG. 4, the brake actuator 30 may be mounted to the brake carrier 20. In at least one configuration, the brake actuator 30 may be mounted to the back wall 88 of the caliper housing 70 and may have a brake actuator shaft that may extend through the opening 82 in the caliper housing 70. The brake actuator shaft may engage the operating shaft 32 and may be moveable to rotate the operating shaft 32.

Referring to FIGS. 4, 5 and 6, the operating shaft 32 may transmit force from the brake actuator 30 other moveable components of the brake assembly 10. In at least one configuration, the operating shaft 32 may generally be configured as an inverted “Y” and may include a lever 110, a pair of cams 112, and a tab 114.

Referring to FIG. 4, the lever 110 may extend from the cams 112 toward the opening 82. The lever 110 may have a pocket that may receive an end of the brake actuator shaft.

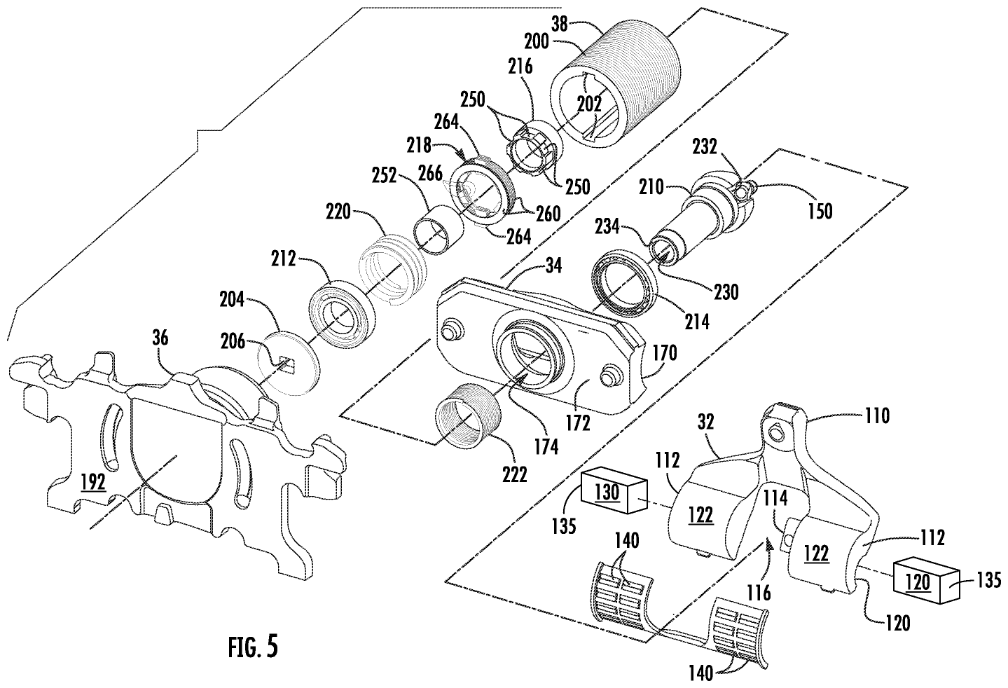

Referring to FIGS. 5 and 6, the cams 112 may be spaced apart from each other such that a gap 116 is provided between the cams 112. In at least one configuration, the cams 112 may have mirror symmetry with respect to each other. In at least one configuration, a cam 112 may include a concave recess 120 and a convex surface 122.

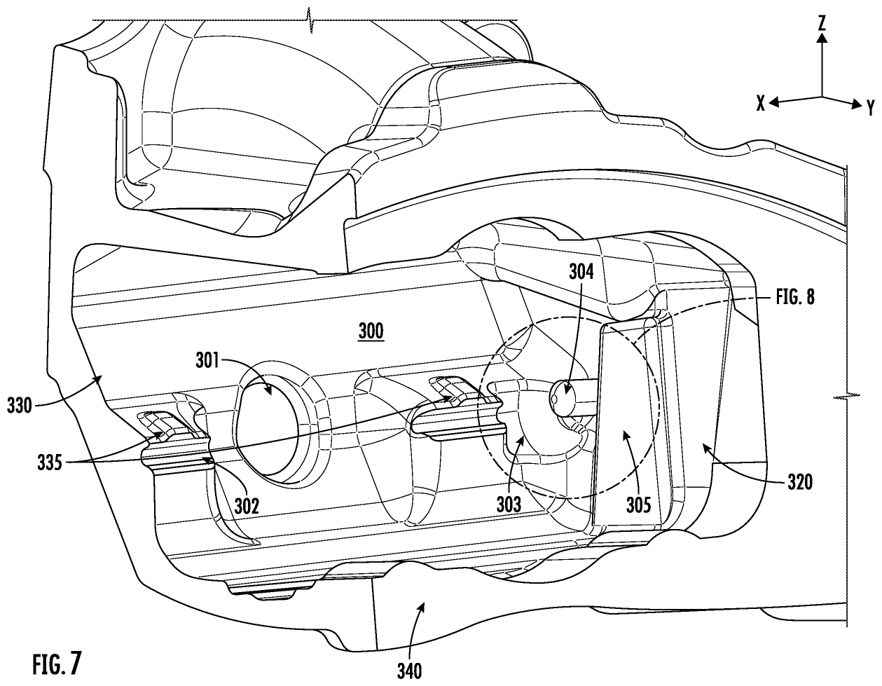

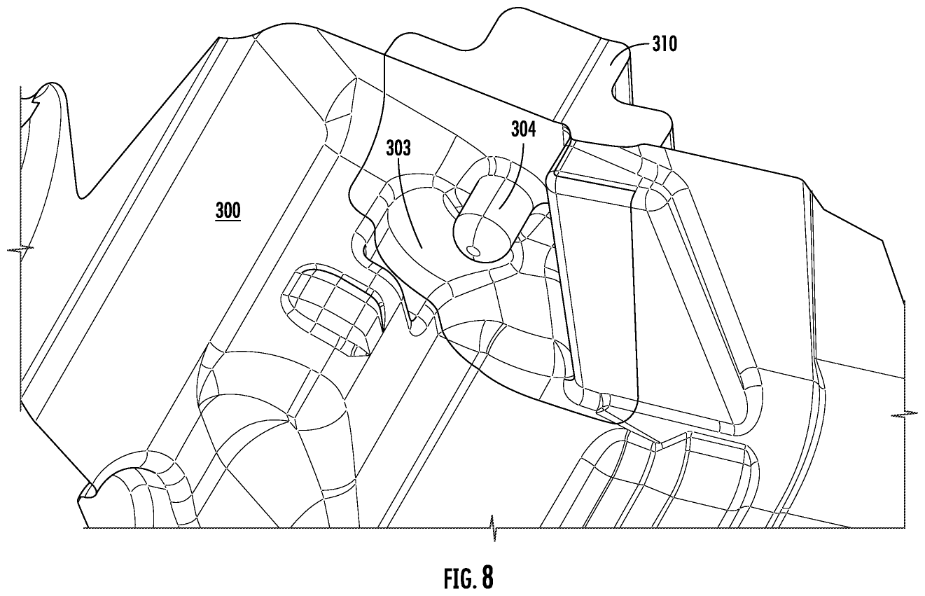

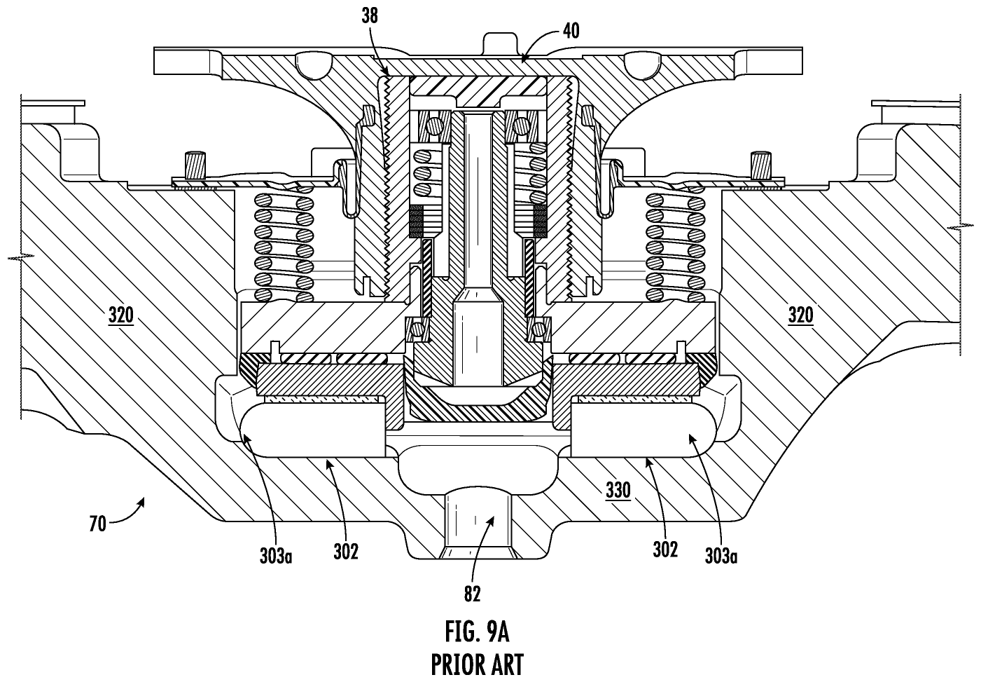

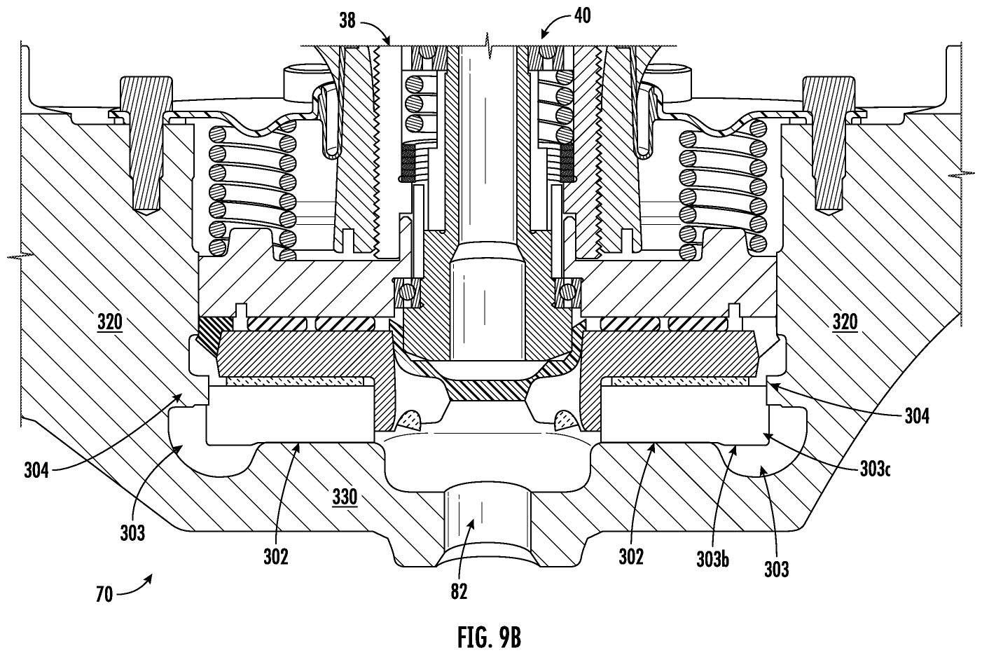

The concave recess 120 of the cam 112 may receive a corresponding roller 130. The roller 130 may be supported by a corresponding surface in the cavity 80 of the caliper housing 70 and may be rotatable about a roller axis of rotation 132, which is best shown in FIG. 4. The defined shapes and geometries of the surfaces of the caliper housing 70 for supporting the roller 130 will be described in detail with reference to FIGS. 7-8, along with the machining via the tool that forms the geometry from the roller 130. As shown in FIGS. 4 to 6, the roller 130 is shown as a square-end roller, with the roller 130 having a flat face 135. The roller 130 generally has a body 131 with an end 133 having the flat face 135. The end 133 of the roller 130 has a square cross-section, thus forming a square-end to the roller 130. The roller, or interchangeably hereinafter referred to as square-end roller 130 is receivable on surfaces of the cavity 80 of the caliper housing 70 based on the machining of the surfaces by the tool in order to optimize the seats and dimensions of the caliper housing 70. Although a square-end roller 130 is described herein, this is not intended to be limiting, and other cross-section shapes are also contemplated. For example, the cross-section may have a polygonal shape, or a circular shape. In embodiments where the roller end 133 has a circular cross-section, the end 133 may have a larger diameter than that of the body 131 such that it is accommodated in the empty zone 303, as referenced with respect to FIGS. 7-8, 9B, and 10. Similarly, the end 133 may be dimensionally larger than the body 131, regardless of shape to be accommodated in the empty zone 303, and as such, discussion of a square-end roller 130 is not intended to be limiting. The end of the roller 130 may also have a flat face 135 for abutting the abutment surfaces (shown as abutment surfaces 303b, 303c in FIG. 9B).

The convex surface 122 of the cam 112 may be disposed opposite the concave recess 120. The convex surface 122 may engage a corresponding set of roller bearings 140 that may be disposed between the convex surface 122 and the yoke 34. The rollers 130 and roller bearings 140 may facilitate rotation of the operating shaft 32 about an axis of rotation. The operating shaft axis of rotation may be disposed at a radial centerline of the convex surface 122.

Referring to FIG. 5, a tab 114 may extend from at least one of the cams 112 into the gap 116. A ball pin 150 may be fixedly mounted to the tab 114 and may extend toward the wear adjuster mechanism 40 as will be discussed in more detail below. In at least one configuration, the ball pin 150 may have a generally spherical or rounded ball at its distal end.

Referring to FIGS. 4, 5 and 6, the yoke 34 may be disposed between the operating shaft 32 and the piston 38. In at least one configuration, the yoke 34 may include a concave surface 170, an engagement surface 172, and a through hole 174. The concave surface 170 may face toward the operating shaft 32 and may engage the roller bearings 140. The engagement surface 172 may be disposed opposite the concave surface 170. The engagement surface 172 may engage or contact an end of the piston 38. The through hole 174 may be disposed proximate the center of the yoke 34 and may extend around an axis 180. The through hole 174 may receive at least a portion of the wear adjuster mechanism 40. The axis 180 may be offset from and may extend substantially parallel to the brake rotor axis of rotation 92.

Referring to FIGS. 4, 5, and 6, the tappet 36 may be moveable along the axis 180 with respect to the caliper housing 70. However, the brake carrier 20 may inhibit or prevent the tappet 36 from rotating about the axis 180. The tappet 36 may protrude away from the cavity 80 of the caliper housing 70 and may have a generally hollow body that may include an inner female thread 190 and an engagement face 192. The inner female thread 190 may face toward the axis 180 and may extend around the axis 180. The engagement face 192 may face away from the cavity 80. The engagement face 192 may engage or contact a brake pad assembly 24. For example, the engagement face 192 may engage or contact a side of the backplate 100 that may be disposed opposite the friction material 102.

Referring to FIGS. 4, 5, and 6, the piston 38 may be at least partially received inside the tappet 36. The piston 38 may be moveable along the axis 180. In addition, the piston 38 may be rotatable about the axis 180. In at least one configuration, the piston 38 may have a hollow tubular configuration that may include an outer female thread 200, at least one recess 202, and an end cap 204. The brake assembly 10 may be provided with a single piston 38 in one or more configurations. The outer female thread 200 may face away from the axis 180 and may extend around the axis 180. The outer female thread 200 may mate with the inner female thread 190 of the tappet 36. As such, the tappet 36 and the piston 38 may have mating threads.

Referring to FIGS. 5 and 6, at least one recess 202 may be provided in an inner surface of the piston 38 that may be disposed opposite the outer female thread 200 and that may face toward the axis 180. In the configuration shown, two recesses 202 are provided that are disposed opposite each other and extend the length of the piston 38. The recesses 202 may facilitate mounting of a disc pack of the wear adjuster mechanism 40.

Referring to FIGS. 4, 5, and 6, the end cap 204 may be disposed at an end of the piston 38 that may face toward the brake pad assembly 24 and the tappet 36. The end cap 204 may be integrally formed with the body of the piston 38 or may be provided as a separate component. In the configuration shown, the end cap 204 is provided as a separate component that may be received in the hollow body of the piston 38. The end cap 204 may be fixed to the piston 38 such that the piston 38 is not rotatable with respect to the end cap 204. In at least one configuration, the end cap 204 may include an engagement feature 206. The engagement feature 206 may have any suitable configuration. For instance, the engagement feature 206 may have a male configuration, a female configuration, or combinations thereof. In the configuration shown, the engagement feature 206 is illustrated as having a female configuration that is configured as a blind hole; however, it is contemplated that such an engagement feature may be configured as a through hole rather than a blind hole. The engagement feature 206 may have any suitable shape or cross-section that may be compatible with a tool as will be discussed in more detail below. For instance, the engagement feature 206 may have multiple sides (e.g., may be slotted or may have a configuration such as a cross, triangular, square, hexagonal, Torx®, etc.). In at least one configuration, the axis 180 may extend through the engagement feature 206.

Referring to FIG. 4, the wear adjuster mechanism 40 may be configured to maintain a desired running clearance between the brake pad assemblies 24 and the brake rotor 60 when the brake pad assemblies 24 are retracted. As an overview, the wear adjuster mechanism 40 may include a one-way clutch that may permit the axial position of a brake pad assembly along the axis 180 to be adjusted or move closer to the brake rotor 60 in response to wear of the friction material 102. The wear adjuster mechanism 40 may be provided in various configurations, some examples of which are disclosed in United States Patent Publication No. 2019/0024740, which is hereby incorporated by reference in its entirety. The wear adjuster mechanism 40 may be at least partially received inside the piston 38. In at least one configuration and as is best shown with reference to FIGS. 4, 6 and 7, the wear adjuster mechanism 40 may include a shaft 210, a first bearing assembly 212, a second bearing assembly 214, a drum 216, a disc pack 218, a first biasing member 220, and a second biasing member 222.

Referring to FIGS. 4, 5, and 6, the shaft 210 may be at least partially received in the cavity 80 of the caliper housing 70. The shaft 210 may be disposed in the through hole 174 of the yoke 34 and inside the hole or cavity of the piston 38. In addition, the shaft 210 may be spaced apart from the yoke 34 and the piston 38. The shaft 210 may be rotatable about the axis 180 and may define a shaft cavity 230 and a ball pin engagement feature 232. The shaft cavity 230 may extend along the axis 180 and may be centered about the axis 180. In at least one configuration, the shaft cavity 230 may be configured as a through hole that may extend along the axis 180 from a first end 234 of the shaft 210 to a second end 236 of the shaft 210 that may be disposed opposite the first end 234 of the shaft 210. The first end 234 may face toward the end cap 204 and may face away from the hole 84 in the caliper housing 70. The second end 236 may be disposed opposite the first end 234 and may face away from the end cap 204 and may face toward the hole 84. The portion of the shaft cavity 230 that may be received inside the yoke 34 may have a larger diameter or may extend further from the axis 180 than a portion of the shaft cavity 230 that may be received inside the piston 38.

The shaft cavity 230 may have any suitable configuration. For instance, the shaft cavity 230 may not have a constant cross-section or a constant diameter from the first end 234 to the second end 236. For instance, the shaft cavity 230 may be sized or configured such that the shaft 210 is disposed closer to the axis 180 at the first end 234 than at the second end 236 or such that the shaft cavity 230 extends further from the axis 180 at the second end 236 than at the first end 234. Such a configuration may facilitate insertion of a tool as will be discussed in more detail below. In at least one configuration, the shaft cavity 230 may have a first portion 240 and a second portion 242.

The first portion 240 may have a different cross-sectional shape, a different size, or both, as compared to the second portion 242. The first portion 240 may extend from the first end 234 or may be disposed closer to the first end 234 than the second portion 242. In the configuration shown, the first portion 240 is illustrated as being disposed closer to the axis 180 than the second portion 242. The first portion 240 may have any suitable shape. For instance, the first portion 240 may have a cylindrical configuration.

The second portion 242 may extend between the first portion 240 and the second end 236. For instance, the second portion 242 may extend from an end of the first portion 240 toward the second end 236 or to the second end 236. In the configuration shown, the second portion 242 is illustrated as being disposed further from the axis 180 than the first portion 240. The second portion 242 may have any suitable shape. For example, the second portion 242 may have a tapered conical configuration that may become progressively larger or may increase in diameter in an axial direction that may extend from the first end 234 toward the second end 236. As such, the shaft cavity 230 may be tapered between the first end 234 and the second end 236. It is also contemplated that the second portion 242 may not have a tapered conical configuration that may have a different configuration that increase the size of the shaft cavity 230 or distance from the axis 180 at the second end 236 as compared to the first end 234. For instance, the second portion 242 may include a plurality of different sized portions or step configuration in which the diameter of the shaft cavity 230 or distance from the axis 180 is greater at the second end 236 as compared to one or more portions that are axially positioned further from the second end 236. In at least one configuration, the second portion 242 may have a greater axial length or extend further along the axis 180 than the first portion 240. It is also contemplated that the first portion 240 may be omitted and the second portion 242 may extend to the first end 234 rather than to the first portion 240.

Referring primarily to FIG. 5, the ball pin engagement feature 232 may be configured to engage the ball pin 150. The ball pin engagement feature 232 may be disposed at an end of the shaft 210 that may face toward the operating shaft 32 and may be offset from the axis 180. In the configuration shown, the ball pin engagement feature 232 is configured as a recess that may receive the ball pin 150. The ball pin 150 may extend at an angle with respect to the axis 180 such that rotation of the operating shaft 32 may cause the ball pin 150 to engage a side or surface of the ball pin engagement feature 232 in a manner that may rotate the shaft 210 about the axis 180. It is also contemplated that the ball pin engagement feature 232 may have a male configuration and the ball pin 150 may have a female configuration in other configurations.

Referring to FIGS. 4, 5, and 6, the first bearing assembly 212 may rotatably support the shaft 210. The first bearing assembly 212 may be disposed proximate a first end of the shaft 210 and may receive the shaft 210. For instance, the first bearing assembly 212 may extend around the shaft 210 and may be received inside the piston 38. As such, the first bearing assembly 212 may extend from the shaft 210 to or toward the inner surface of the piston 38.

The second bearing assembly 214 may rotatably support the shaft 210. The second bearing assembly 214 may be disposed proximate a second end of the shaft 210 and may receive the shaft 210. For instance, the second bearing assembly 214 may extend around the shaft 210 and may be received inside the through hole 174 of the yoke 34. As such, the second bearing assembly 214 may extend from the shaft 210 to or toward the yoke 34.

The drum 216 may be received inside the piston 38 and may be spaced apart from the piston 38. The drum 216 may extend around and may receive a portion of the shaft 210. In addition, the shaft 210 may be selectively rotatable about the axis 180 with respect to the drum 216 as will be discussed in more detail below. In at least one configuration, the drum 216 may have a hollow tubular construction that may include at least one recess 250. As is best shown in FIG. 5, a plurality of recesses 250 are arranged around an exterior side of the drum 216 that faces away from the axis 180. The recesses 250 may extend from an end of the drum 216 that may face toward the tappet 36 toward an opposite end of the drum 216. The recesses 250 may facilitate mounting of the disc pack 218. As is best shown in FIG. 4, axial movement of the drum 216 may be constrained by the shaft 210 and by a spacer 252 that may extend from an end of the drum 216 to the first bearing assembly 212.

Referring to FIGS. 4, 5, and 6, the disc pack 218 may selectively couple the piston 38 and the drum 216. The disc pack 218 may include a plurality of discs that may include at least one outer disc 260 and at least one inner disc 262. As is best shown in FIGS. 5 and 6, the outer discs 260 may have at least one tab 264 that may be received in a recess 202 of the piston 38. As such, the outer discs 260 may be rotatable about the axis 180 with the piston 38. The inner discs 262 may have at least one tab 266 that may be received in a recess 250 of the drum 216. As such, the inner discs 262 may be rotatable about the axis 180 with the drum 216. The outer discs 260 and the inner discs 262 may be arranged in an alternating order in an axial direction or in a direction that extends along the axis 180. For instance, at least one inner disc 262 may be axially positioned between two adjacent outer discs 260 or vice versa. The piston 38 may be rotatable about the axis 180 with the drum 216 when the discs of the disc pack 218 are sufficiently compressed such that the outer discs 260 and the inner discs 262 do not slip with respect to each other. Conversely, the drum 216 may be rotatable with respect to the piston 38 when the discs of the disc pack 218 are not sufficiently compressed or when the outer discs 260 and the inner discs 262 slip with respect to each other.

Referring to FIGS. 4, 5, and 6, the first biasing member 220 may exert a biasing force on the disc pack 218. The first biasing member 220 may have any suitable configuration. For instance, the first biasing member 220 may be configured as a spring that may extend from the first bearing assembly 212 to the disc pack 218 and that may exert a biasing force on the disc pack 218 in a direction that may extend toward the yoke 34. As such, the first biasing member 220 may compress the discs of the disc pack 218.

The second biasing member 222 may selectively couple the shaft 210 and the drum 216. The second biasing member 222 may have any suitable configuration. For example, the second biasing member 222 may be configured as a wrap spring that may be axially positioned between the disc pack 218 and the second bearing assembly 214. The second biasing member 222 may be partially received inside the yoke 34 and may be partially received inside the piston 38. The second biasing member 222 may extend around the shaft 210 and may extend around a portion of the drum 216. The second biasing member 222 may be configured to slip and allow the shaft 210 to rotate with respect to the drum 216 and the piston 38 when the brake is released or braking is disengaged as will be discussed in more detail below.

One or more retraction springs may be provided to facilitate retraction of the brake pad assemblies 24. A retraction spring may be received in the cavity 80 of the caliper housing 70 and may extend from the yoke 34 to the cover plate 86. The retraction spring may be configured to actuate the yoke 34 away from the cover plate 86 since the cover plate 86 is fixed to the caliper housing 70. As such, the retraction spring may urge the yoke 34 to move along the axis 180 in a direction that extends away from the brake rotor 60 and the cover plate 86.

Referring to FIG. 4, operation of the brake assembly 10 will now be described in more detail. As an overview, the brake assembly 10 may start in a retracted state in which braking of the vehicle is not requested. As such, the brake pad assemblies 24 may be retracted away from the brake rotor 60 and components of the brake assembly 10 may be positioned as shown. Braking may be initiated in response to a vehicle braking command, such as may be provided by an input device like a brake pedal or sensor that may trigger braking of the vehicle, such as an adaptive cruise control system or a proximity sensor that may detect an object or obstruction in front of the direction of travel of the vehicle. The brake actuator 30 may be operated to extend the brake actuator shaft, thereby rotating the operating shaft 32 about its axis of rotation in a first direction or a counterclockwise direction from the perspective shown. Rotation of the operating shaft 32 may move the yoke 34, tappet 36, piston 38, wear adjuster mechanism 40, and the inboard brake pad assembly 24 that is disposed adjacent to the tappet 36 along the axis 180 toward the brake rotor 60 or to the left from the perspective shown. Movement of the yoke 34 toward the brake rotor 60 may compress the retraction springs. In addition, rotation of the operating shaft 32 may cause the ball pin 150 to engage the ball pin engagement feature 232 of the shaft 210, which may rotate the shaft 210 about the axis 180. Once the inboard brake pad assembly 24 contacts the brake rotor 60 a reaction force may then move the brake caliper 22 with respect to the brake carrier 20 to actuate the outboard brake pad assembly 24 that is disposed between the brake rotor 60 and the caliper bridge 72 into engagement with an opposite side of the brake rotor 60 to help slow rotation of the brake rotor 60 and an associated vehicle wheel. Retracting the brake actuator shaft may allow the operating shaft 32 to rotate about its axis of rotation in a clockwise direction from the perspective shown, which in turn may allow the actuation sequence to proceed in reverse under the biasing force of the retraction springs.

Rotation of the operating shaft 32 may or may not result in adjustment of the running clearance between the brake pad assembly 24 and the brake rotor 60. For example, rotation of the operating shaft 32 in the first direction may operate the wear adjuster mechanism 40 to extend the tappet 36 closer to the brake rotor 60 with respect to the piston 38 when the operating shaft 32 and the ball pin 150 rotate the shaft 210 about the axis 180 before the inboard brake pad assembly 24 contacts the brake rotor 60. As such, the shaft 210 and the drum 216 may rotate together about the axis 180 due to the force exerted by the second biasing member 222. Rotation of the drum 216 may cause the piston 38 to rotate about the axis 180 due to the coupling provided by the disc pack 218. Rotation of the piston 38 may extend the tappet 36 (i.e., extend the tappet 36 further away from the yoke 34 and closer to the brake rotor 60) due to the mating of the outer female thread 200 of the piston 38 and the inner female thread 190 of the tappet 36. For example, rotation of the piston 38 may cause the tappet 36 to extend to the left from the perspective shown with respect to the piston 38 due to operation of the mating threads since the tappet 36 is inhibited from rotating about the axis 180 by the brake carrier 20. Extension of the tappet 36 with respect to the piston 38 may stop when the inboard brake pad assembly 24 contacts the brake rotor 60. For example, the torque required to rotate the piston 38 increases substantially when the inboard brake pad assembly 24 contacts the brake rotor 60 even when the brake actuator 30 continues to rotate the operating shaft 32 and hence continues to rotate the shaft 210. As a result, the discs of the disc pack 218 may slip with respect to each other, thereby permitting rotation of the shaft 210 with respect to the piston 38.

The wear adjuster mechanism 40 may operate to hold the tappet 36 in its adjusted position when the brake pad assemblies 24 are retracted. For example, when the brake actuator 30 is retracted the operating shaft 32 may rotate in a second direction that is disposed opposite the first direction, or clockwise from the perspective shown. The ball pin 150 may then rotate the shaft 210 in the opposite direction back to its previous rotational position. However, the force exerted by the disc pack 218 may exceed the force exerted by the second biasing member 222. As a result, the disc pack 218 may inhibit rotation of the piston 38 about the axis 180 with respect to the drum 216 while the second biasing member 222 may slip or allow the shaft 210 to rotate about the axis 180 in the second direction with respect to the drum 216 and back to its previous position.

Rotation of the operating shaft 32 may not result in adjustment of the running clearance between the brake pad assembly 24 and the brake rotor 60 when the inboard brake pad assembly 24 contacts the brake rotor 60 before the operating shaft 32 and the ball pin 150 rotate the shaft 210 about the axis 180. As previously discussed, the torque required to rotate the piston 38 increases substantially when the inboard brake pad assembly 24 contacts the brake rotor 60. As a result, the discs of the disc pack 218 may slip with respect to each other as the operating shaft 32 rotates in the first direction, thereby permitting rotation of the shaft 210 with respect to the piston 38 while rotation of the piston 38 is opposed by the tappet 36 reacting against the brake rotor 60. The wear adjuster mechanism 40 may operate to hold the tappet 36 in its current position when the brake pad assemblies 24 are retracted (e.g., the disc pack 218 may inhibit rotation of the piston 38 about the axis 180 while the second biasing member 222 may slip or allow the shaft 210 to rotate about the axis 180 and back to its previous position as previously described).

Referring to FIG. 4, the cavity 80 inside the caliper housing 70 may be sealed from the surrounding environment to inhibit moisture or water from entering the cavity 80. For example, the brake actuator 30 and the cover plate 86 may directly or indirectly seal against the caliper housing 70, such as with an intervening seal or gasket that may facilitate sealing of a corresponding opening of the caliper housing 70. Similarly, a flexible boot 270 may extend from the tappet 36 to the caliper housing 70 and/or the cover plate 86 to provide sealing between the tappet 36 and the caliper housing 70 while accommodating movement of the tappet 36. In addition, the hole 84 in the caliper housing 70 may receive a component such as a plug 280 that may facilitate sealing of the hole 84. The plug 280 may be coupled to the caliper housing 70 in any suitable manner, such as with mating threads, an interference fit, or with another component that helps secure the plug 280.

Referring to FIGS. 7, 8, 9B, and 10, a caliper housing 70 is shown according to an embodiment. The caliper housing 70 includes end walls 320 (with only a first end wall shown in FIGS. 8 and 9), with a transverse wall 330 extending in the X-direction therebetween. The transverse wall 330 includes a roller seat 302 with bearing protrusions 335 protruding from the surface above the roller seat 302, with the bearing protrusions 335 providing bearing surfaces that may be adapted to rotatably support the operating shaft 32. One or both of the end walls 320 includes an end stop 304 and a saddle wall 305 defined along the surface of the end wall. The end stop 304 (or interchangeably the button 304) protrudes from at least one wall of the end walls 320. In at least one embodiment, the end stop 304 protrudes along an axis generally parallel to an axis of the transverse wall (i.e., X-direction). In a further embodiment, the end stop 304 may protrude farther out from the end wall 320 than the saddle wall 305.

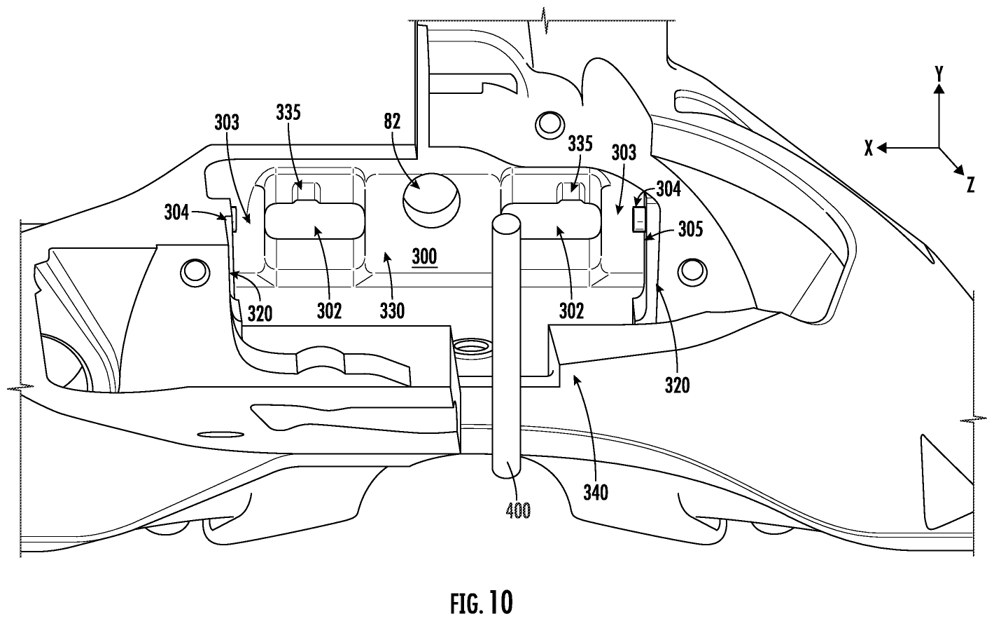

The caliper housing 70 also includes an interface wall 340 (or back wall 88 as shown in previous Figures) that extends between the end walls 320 and the transverse wall 330, with the interface wall 340 cooperating with the end walls 320 and the transverse wall 330 to at least partially define the cavity 80 in the caliper housing 70. As such, the interface wall 340 may be disposed opposite the transverse wall 330 of the caliper housing 70. The interface wall 340 may further include a hole 84 (not shown in FIGS. 7-9B), that is sized to receive a cutting tool 400 (shown schematically in FIG. 10) therethrough to machine surfaces of the caliper housing 70.

The caliper housing 70 is generally casted from a molten material, such that the end walls 320 and transverse wall 330 include one or more surfaces 300 (e.g., surface 301, the roller seat 302, an empty zone (or interchangeably fresh air run off) 303, and the end stop 304) having a specific geometry or shape. The surfaces 300 of the caliper housing 70 may be altered or further defined, such as by machining by the cutting tool 400, such that material is removed from surfaces 300 of the cast caliper housing 70 in order to define openings (such as via machining of surface 301 into opening 82) and specific profiles of surfaces to accommodate and/or abut the end 133 of the roller 130. The transverse wall 330 thus defines the roller seat 302, having discrete portions spaced apart by a gap extending along the transverse wall 330. Between discrete portions of the roller seat surface 302, is the surface 301 as shown in FIG. 7, which may be machined to form an opening (e.g., opening 82) in the transverse wall 330, as shown in FIG. 10.

As described herein, the roller 130 may be referred to as square-end roller 130, however as previously discussed, other shapes (i.e., other polygons or circles) for the cross-section of the end 133 are also contemplated, as well as dimensionally larger ends of the roller 130 as compared to the body portion, such that the end 133 is accommodated in the empty zone 303. It is further contemplated that the cutting tool 400 may be any suitable tool to cut and machine the roller seat 302 such that the end of the roller seat 302 for accommodating the end 133 of the roller 130 define flat abutment surfaces (shown as generally perpendicular abutment surfaces 303b, 303c in FIG. 9B), as opposed to the conventional curved abutment surfaces 303a as shown in FIG. 9A. For example, the cutting tool 400, as shown in FIG. 10, may be advanced into the caliper housing 70 (i.e., via the hole 84 in the interface wall 340), and may be moved left to right in the X-direction to cut the surface to machine the roller seat 302. The cutting tool 400 may machine the roller seat 302 by moving toward the end wall 320 and the end stop 304, and may be, in some embodiments, repeated symmetrically on the other side of the caliper housing 70 before being advanced out of the caliper housing 70.

With reference again to FIGS. 7, 8, 9B, and 10, the surfaces 300 of the caliper housing also include the empty zone 303 defined along the transverse wall 330, which allows for a fresh air run off, where the cutting tool can be moved off the end of the roller seat 302 toward the end stop 304. This forms an area which can accommodate the end 133 of the square-end roller 130 (or, in other embodiments, other shaped ends 133 or dimensionally larger ends 133 than the body 131 of the roller, as previously described), without restriction on the roller end shape or size. The surfaces 300 may, in certain embodiments as shown in FIG. 9B, thus form surfaces of the caliper housing 70 (such as abutment surfaces 303b, 303c) designed to accommodate the square-end roller 130, as well as for the saddle or yolk to react against. Furthermore, the caliper housing 70 can be machined to form relief areas, for example defined as a lower portion of empty zone 303, such as for paint to pool, without obstructing operation of the brake. In certain embodiments, where the cutting tool has a spherical end (i.e., a ball nose cutter), the tool may further be equipped with a cutter that can remove corners of machined spherical end surfaces in order to form additional flat abutment surfaces within the caliper housing 70. Although shown in FIG. 10 as having a spherical cutting end, the cutting tool 400 may be any suitable shape in order to achieve the Referring to FIG. 8, a portion of the caliper housing 70 of FIG. 7 is shown, prior to machining of the roller seat 302. Specifically, this portion generally shows the empty zone 303 and end stop 304 of FIG. 7 in closer detail. The tooling to cast the caliper housing 70 may include a removable insert 310 on either side of the tooling corresponding to the empty zone 303 and the end stop 304 to facilitate formation of the surfaces, such that the machining of these surfaces may be limited.

A method of manufacturing a brake caliper housing 70 is also provided. The method includes providing the brake caliper housing 70, the brake caliper housing 70 having a first end wall 320; a second end wall 320 disposed opposite the first end wall 320; a transverse wall 330 that extends from the first end wall 320 to the second end wall; an interface wall 340 that extends from the first end wall 320 to the second end wall 320, opposite to the transverse wall 330, with the interface wall 340 cooperating with the first end wall 320, the second end wall 320, and the transverse wall 330 to at least partially define a cavity, and the interface wall defining a hole 84. The brake caliper housing 70 also has a roller seat 302 defined in the transverse wall 330 adapted to support a roller 130. The method further includes inserting a cutting tool 400 through the hole 84 in the interface wall 340, the cutting tool 400 adapted to machine surfaces 300 of the brake caliper housing 70; and machining the roller seat 302 with the cutting tool 400 such that flat abutment surfaces 303b, 303c are formed to accommodate an end 133 of the roller 130.

The method may further include providing the roller 130 having a body 131 with an end 133 having a polygonal cross-section or an enlarged cross-section relative to a diameter of the body to be accommodated in the roller seat 302. The end of the roller 130 may have a flat face 135 for abutting the abutment surfaces 303b, 303c. The flat abutment surfaces 303b, 303c may be generally perpendicular to each other. In at least one embodiment, the cutting tool 400 may be a ball nose cutter or a flat ended endmill. In at least one embodiment, the machining of the roller seat may include inserting a second cutting tool, after removal of the cutting tool, to complete formation of the flat abutment surfaces. For example, a spherical tip cutting tool may form a conventional roller seat (similar to that shown in FIG. 9A), and a second cutting tool with a different tip may be inserted to machine the roller seat in order to remove material to form the flat abutment surfaces 303b, 303c such that a polygonal (or square) roller end can be accommodated in the roller seat. In other embodiments, the brake caliper housing may further include an empty zone defined in the transverse wall between the roller seat and a respective end wall of the first and second end walls, the empty zone corresponding to the end of the roller. The machining step includes the cutting tool running off an end of the roller seat into the empty zone to form the flat abutment surfaces.

Thus, the access to the caliper housing 70 through one of the walls (i.e., the interface wall) of the brake assembly allows a cutting tool 400 to be advanced and rotated at various angles and may enable better access to machine the surfaces to create geometries for supporting a square-end (or other end shaped or sized) roller, resulting in a caliper housing with surfaces with defined geometries to cooperate and abut with a flat end of a roller (i.e., the square-end roller).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A brake caliper housing comprising:
a first end wall;
a second end wall disposed opposite the first end wall;
a transverse wall that extends from the first end wall to the second end wall;
an interface wall that extends from the first end wall to the second end wall, and opposite to the transverse wall, the interface wall cooperating with the first end wall, the second end wall, and the transverse wall to at least partially define a cavity, the interface wall defining a hole sized to receive a cutting tool adapted to machine a surface in the brake caliper housing; and
a roller seat defined in the transverse wall adapted to support a roller having a body with an end having a polygonal cross-section or an enlarged cross-section relative to a diameter of the body, the roller seat having flat abutment surfaces for accommodating the end of the roller.

2. The brake caliper housing of claim 1, further comprising:
an empty zone defined in the transverse wall between the roller seat and a respective end wall of the first and second end walls, the empty zone adapted to allow the cutting tool to run off the roller seat such that the end of the roller can be accommodated in the empty zone.

3. The brake caliper housing of claim 1, further comprising an end stop protruding from at least one wall of the first and second end walls.

4. The brake caliper housing of claim 3, wherein the end stop protrudes along an axis generally parallel to the transverse wall toward the other of the first and second walls.

5. The brake caliper housing of claim 1, wherein the cross-section of the end is a square end.

6. The brake caliper housing of claim 1, wherein the cross-section of the end of the roller is circular, and a diameter of the end is larger than a diameter of a cross-section of the body.

7. The brake caliper housing of claim 1, wherein the cutting tool is a ball nose cutter.

8. The brake caliper housing of claim 1, wherein the cutting tool is a flat ended endmill.

9. The brake caliper housing of claim 1, further comprising at least one bearing protrusion formed above the roller seat and defining a bearing surface adapted to support an operating shaft.

10. A method of manufacturing a brake caliper housing comprising:
providing the brake caliper housing, the brake caliper housing having
a first end wall;
a second end wall disposed opposite the first end wall;
a transverse wall that extends from the first end wall to the second end wall;
an interface wall that extends from the first end wall to the second end wall, opposite to the transverse wall, the interface wall cooperating with the first end wall, the second end wall, and the transverse wall to at least partially define a cavity, the interface wall defining a hole; and
a roller seat defined in the transverse wall adapted to support a roller;
inserting a cutting tool through the hole in the interface wall, the cutting tool adapted to machine surfaces of the brake caliper housing; and
machining the roller seat with the cutting tool such that flat abutment surfaces are formed to accommodate an end of the roller.

11. The method of claim 10, further comprising:
providing the roller having a body with an end having a polygonal cross-section or an enlarged cross-section relative to a diameter of the body to be accommodated in the roller seat.

12. The method of claim 10, wherein the cutting tool is a ball nose cutter or a flat ended endmill.

13. The method of claim 10, wherein the flat abutment surfaces are generally perpendicular to each other.

14. The method of claim 10, wherein the machining further includes inserting a second cutting tool, after removal of the cutting tool, to complete formation of the flat abutment surfaces.

15. The method of claim 10, wherein the brake caliper housing further includes an empty zone defined in the transverse wall between the roller seat and a respective end wall of the first and second end walls, the empty zone corresponding to the end of the roller.

16. The method of claim 15, wherein the machining includes running the cutting tool off an end of the roller seat into the empty zone to form the flat abutment surfaces.

17. A brake caliper housing comprising:
a first end wall;
a second end wall disposed opposite the first end wall;
a transverse wall that extends from the first end wall to the second end wall;
an interface wall that extends from the first end wall to the second end wall, opposite to the transverse wall, the interface wall cooperating with the first end wall, the second end wall, and the transverse wall to at least partially define a cavity, and defining a hole to provide access to the cavity and sized to receive a cutting tool adapted to machine surfaces around the cavity of the brake caliper housing;
a roller seat defined in the transverse wall;
an empty zone defined in the transverse wall between the roller seat and one of the first and second end walls, the empty zone providing a run-off for the cutting tool when machining the roller seat; and
a roller having a body with an end having a polygonal cross-section, the body being accommodated in the roller seat and the end being accommodated in the empty zone.

18. The brake caliper housing of claim 17, wherein the roller seat defines flat abutment surfaces corresponding to the end of the roller.

19. The brake caliper housing of claim 17, wherein the polygonal cross-section is a square cross-section.

20. The brake caliper housing of claim 17, wherein the empty zone includes a relief portion adapted to receive excess paint.
